(19) United States
(12) Patent Application Publication
(10) Pub. No.: US 2025/0181553 A1
(43) Pub. Date: Jun. 5, 2025

(54) FILE OPERATION RECORD TRACEABILITY SYSTEM AND TRACEABILITY METHOD

(71) Applicant: Hangzhou Laibu Technology Co., Ltd., Hangzhou (CN)

(72) Inventors: Xiaojun Zhu, Hangzhou (CN); Yanhua Li, Hangzhou (CN)

(21) Appl. No.: 18/943,875

(22) Filed: Nov. 11, 2024

(30) Foreign Application Priority Data
Nov. 30, 2023 (CN) 202311632046.0

(51) Int. Cl. G06F 16/11; G06F 16/182

(52) U.S. Cl. CPC G06F 16/122; G06F 16/182

(57) ABSTRACT

The invention relates to a file operation record traceability system and traceability method. In the system, an intelligent terminal adds a preset file containing file mark information and file flow information header to an original file to generate a target file. The operating system of the intelligent terminal records the operation record information of the target file. The intelligent terminal uploads the operation record information, the file mark information and the current user information in the file flow information to the cloud server for storage. The management terminal sends a viewing request to the cloud server, and the cloud server sends the operation record information and the user information to the management terminal. The invention uses the file header and the operating system to record the file operation record, and uses the cloud to store the file operation record, thus conveniently tracing the whole usage process of the file.

### CROSS REFERENCE TO RELATED APPLICATIONS

The present application claims the benefit of Chinese Patent Application No. 2023116320460 filed on Nov. 30, 2023, the contents of which are incorporated herein by reference in their entirety.

### TECHNICAL FIELD

The present invention relates to the field of data security, and more particularly to a file operation record traceability system and a file operation record traceability method.

### DESCRIPTION OF RELATED ART

In the information age, information security is becoming more and more important for users. In the existing file usage scenarios, the leakage of private files is a thorny problem. Once a private file is leaked, one is that it will cause security accidents, and the other is that it is very difficult or even powerless to find the source of the leakage quickly. In order to solve this problem, existing systems usually use cloud systems and clients to install proprietary tools and encrypt files, and then the cloud system needs to decrypt and use them, and record them during use to facilitate traceability. The disadvantage of this method is that once the file is decrypted and used, the user's operation on the file can no longer be traced back.

### BRIEF SUMMARY OF THE INVENTION

The technical problem to be solved by the present invention is to provide a file operation record traceability system and a file operation record traceability method.

The technical solution adopted by the present invention to solve the technical problem is that: a file operation record traceability system is provided, which comprises an intelligent terminal, a cloud server and a management terminal, and the cloud server communicatively connects the intelligent terminal and the management terminal;

The intelligent terminal is used for adding a preset file header to an original file to generate a target file, wherein the preset file header contains file mark information for marking the uniqueness of the file and file flow information for recording a file user; And the operating system of the intelligent terminal records operation record information of the target file in the process of using the target file; And uploading the operation record information, the file mark information, and the current user information in the file flow information to the cloud server;

The management terminal is used for sending a viewing request with the file mark information to the cloud server;

The cloud server is used for storing the operation record information, the file mark information, and the user information, and sending the operation record information and the user information corresponding to the file mark information in the viewing request to the management terminal.

Further, in the file operation record traceability system according to the present invention, the intelligent terminal is further used for recording current user information into the file flow information when the target file changes a user.

Further, in the file operation record traceability system according to the present invention, the intelligent terminal calls an application program corresponding to the target file to use the target file.

Further, in the file operation record traceability system according to the present invention, the operating system of the intelligent terminal is installed with an operating system extension module for recording the operation record information of the user using the target file.

When the intelligent terminal derives a new target file from the target file, the new target file inherits file mark information and file flow information of the target file, and generates new file mark information.

Further, in the file operation record traceability system according to the present invention, the operation record information comprises at least one of a file usage time, a file editing operation, a file copying operation, a file transfer operation, a file printing operation, and a file screenshot operation.

In addition, the present invention also provides a file operation record traceability method, comprising the following steps:

Adding a preset file header to an original file to generate a target file, the preset file header contains file mark information for marking file uniqueness and file flow information for recording file users;

The operating system of the intelligent terminal records operation record information of the target file in a process of the intelligent terminal using the target file;

The intelligent terminal uploads current user information in the operation record information, the file mark information, and current user information in the file flow information to a cloud server for storage;

The management terminal sends a viewing request with the file mark information to the cloud server, and the cloud server sends the operation record information and user information corresponding to the file mark information to the management terminal.

Further, in the file operation record traceability method according to the present invention, the method further comprises:
recording current user information in the file flow information when the user of the target file is changed.

Further, in the file operation record traceability method according to the present invention, the intelligent terminal using the target file comprises:

The intelligent terminal calls an application program corresponding to the target file for using the target file.

Further, in the file operation record traceability method according to the present invention, before the operating system of the intelligent terminal records the operation record information of the target file in the process of using the target file by the intelligent terminal, the operating system extension module for recording the operation record information of the user using the file is added to the operating system of the intelligent terminal;

After adding a preset file header to an original file to generate a target file, further comprises: when the intelligent terminal derives a new target file from the target file, the new target file inherits file mark information and file flow information of the target file, and generates new file mark information.

Further, in the file operation record traceability method according to the present invention, the operation record information comprises at least one of a file usage time, a file editing operation, a file copying operation, a file transfer operation, a file printing operation, and a file screenshot operation.

A file operation record traceability system and a file operation record traceability method of the present invention have the following beneficial effects: the invention uses a file header and an operating system to record the file operation record, and uses a cloud to save the file operation record, thereby facilitating the traceability of the entire usage process of the file.

### BRIEF DESCRIPTION OF THE SEVERAL VIEWS OF THE DRAWINGS

The present invention will be further described below with reference to the accompanying drawings and examples, in which:

FIG. 1 is a schematic diagram of a file operation record traceability system according to an embodiment of the present invention.

FIG. 2 is a flowchart of a file operation record traceability method according to an embodiment of the present invention.

### DETAILED DESCRIPTION OF THE INVENTION

In order to have a clearer understanding of the technical features, objects and effects of the present invention, specific embodiments of the present invention will now be described in detail with reference to the accompanying drawings.

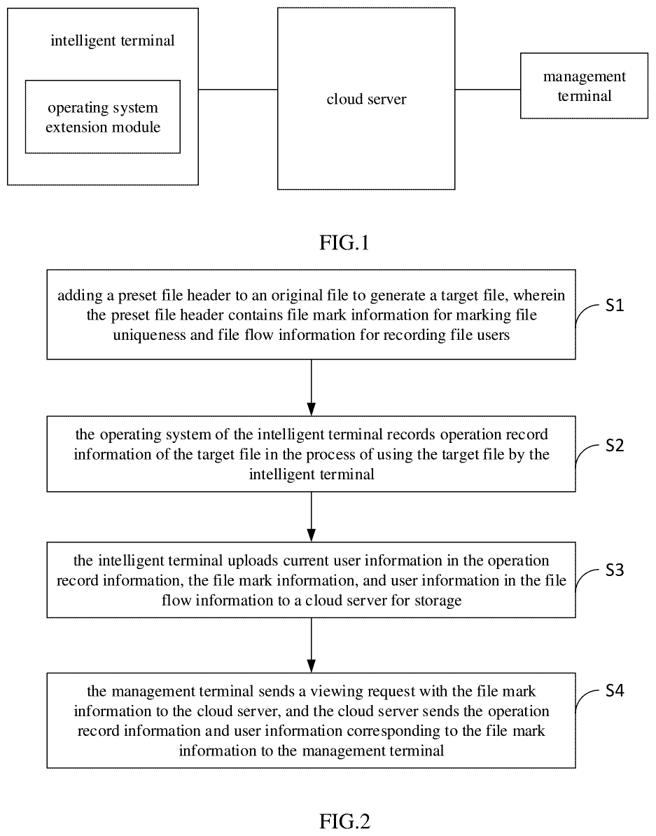

In a preferred embodiment, referring to FIG. 1, the present embodiment provides a file operation record traceability system for tracing a file flow process and a file usage process. The file operation record traceability system comprises an intelligent terminal, a cloud server and a management terminal, and the cloud server communicatively connects with the intelligent terminal and the management terminal. It can be understood that the file operation record traceability system of the present embodiment can be simultaneously connected to a plurality of intelligent terminals and a plurality of management terminals, and the present embodiment is illustrated by taking one intelligent terminal and one management terminal as an example, and the plurality of intelligent terminals and the plurality of management terminals can be implemented by reference. As an alternative, the intelligent terminal can be a desktop computer, a notebook computer, a tablet computer, a smart phone, a vehicle terminal, or the like; the management terminal can be a desktop computer, a notebook computer, a tablet computer, a smart phone, a vehicle terminal, or the like.

Since the intelligent terminal is a terminal for viewing and using files by the user, the operating system of the existing intelligent terminal cannot record the operation record information of the user using the file and upload the operation record information to the cloud server, in order to realize the tracing of the file usage record, the present embodiment needs to first install an operating system extension module for recording the operation record information of the user using the target file on the operating system of the existing intelligent terminal. The operating system extension module is different from an ordinary application program, which is only installed in the operating system, whereas the operating system extension module of the present embodiment is a part of the operating system.

After the operating system extension module is installed in the operating system of the intelligent terminal, it is necessary to cooperate with the file in the specific format of the present embodiment in order to realize the recording of the file usage process. The intelligent terminal of the present embodiment adds a preset file header to the original file to generate a target file, the preset file header comprises file mark information for marking the uniqueness of the file and file flow information for recording the file user, and each target file has unique file mark information, that is, the target file and the file mark information are one-to-one correspondence. The intelligent terminal records the current user information into the file flow information when the user of the target file is changed, and the file flow information records all the file users, that is, the file users are recorded once every time the target file is transmitted or used. That is to say, all users who have used the target file will be recorded in the file flow information. Alternatively, the file user may be information that can uniquely identify the user's identity, such as the real name of the user, the registered account number, the physical address and the IP address of the intelligent terminal.

The preset file header of the target file stores file mark information and file flow information. In order to enable the operating system of the intelligent terminal to find the position of the file mark information and the file flow information in the preset file header, the present embodiment sets a first mark bit and a second mark bit for marking the position for the file mark information and the file flow information in the preset file header, respectively, that is, the first mark bit is used for marking the position of the file mark information and the second mark bit is used for marking the position of the file mark information, the second mark bit is used for marking the position of the file flow information. When the operating system of the intelligent terminal uses the target file, the operating system of the intelligent terminal can recognize the first mark bit and the second mark bit, read the file mark information in the preset file header according to the first mark bit, and read the file flow information in the preset file header according to the second mark bit.

Here, the original file refers to a file in which the file operation record traceability system of the present embodiment is not used, that is, any file in the prior art, where the file refers to a data set containing a certain amount of data, for example, the original file may be a word file, a PDF file, a picture file, an audio file, a video file, a drawing file, or the like. It can be understood that after the original file is converted to the target file, the subsequent target file can be directly used after being transferred to other intelligent terminals, and there is no need to add a preset file header to the target file again.

It should be noted that when the intelligent terminal adds a preset file header to the original file to generate the target file, the normal use of the original file will not be affected, and the operating system can still call the application program corresponding to the target file when the target file is used. That is to say, when the original file is converted to the target file of a specific format, the correspondence between the original file and the application program is still retained, thus ensuring that the original file can be used normally after being converted to the target file.

When the intelligent terminal uses the target file, the intelligent terminal calls an application program corresponding to the target file to use the target file. In the process of using the target file, the operating system of the intelligent terminal records operation record information of the target file in the process of using the target file, and the operation record information refers to various operations performed by the user in the process of using the target file. Optionally, the operation record information comprises, but is not limited to, file usage time, file editing operation, file copying operation, file transfer operation, file printing operation, file screenshot operation, etc., and specific contents of the operation record information to be recorded can be selected as needed in the system setting process.

After acquiring the operation record information, the operating system of the intelligent terminal uploads the current user information in the operation record information, the file mark information, and the file flow information, and the correspondence relationship in the operation record information, the file mark information, and the current user information to the cloud server.

After receiving the operation record information, the file mark information, and the current user information, and the correspondence between them, the cloud server stores the operation record information, the file mark information, and the current user information, and the correspondence between them in the cloud server. In order to facilitate data storage and user search, because the file mark information is the unique mark information of the target file, the data is stored by the file mark information, that is, the operation record information and the user information corresponding to the same file mark information are stored together. Alternatively, when operation record information and user information corresponding to the same file mark information are stored together, the operation record information and user information are stored in chronological order.

When the user needs to view the destination file for traceability, the management terminal sends a viewing request with file mark information to the cloud server. The cloud server searches the operation record information and the user information corresponding to the file mark information, and sends the searched operation record information and the user information to the management terminal, and the management terminal displays the operation record information and the user information for the user to view. Further, if it is desired to accurately search the operation record information of a certain user using a certain destination file, the viewing request sent by the management terminal comprises the file mark information and the user information, and the cloud server searches the operation record information corresponding to both the file mark information and the user information, and sends the searched operation record information to the management terminal, and the management terminal displays the operation record information for the user to view.

The file operation record traceability system of the present embodiment uses a file header and an operating system to record the file operation record, and uses a cloud to store the file operation record, thereby facilitating the traceability of the entire usage process of the file.

In a file operation record traceability system according to some embodiments, in addition to the single use and circulation use of the target file according to the above embodiments, a new file may be generated based on the target file, such as copying the target file to generate a new file, modifying the target file and saving it as a new file, or changing the storage format of the target file. In view of this situation, when a new target file is derived from the target file, the intelligent terminal of the present embodiment causes the new target file to inherit the file mark information and the file flow information of the target file, so that the genetic information of the target file can be inherited to facilitate subsequent traceability requirements. In addition, the new target file still comprises a preset file header and unique corresponding new file mark information, that is, the new target file can still record file flow information like the target file of the above-described embodiment, and can cooperate with the operating system to complete operations such as uploading operation record information of the new target file, and the like. For details, please refer to the above-described embodiment. In this embodiment, the derivative file based on the target file inherits the genetic information of the target file, which can ensure the continuous storage of the file usage information, and facilitate the traceability of the file.

In a preferred embodiment, referring to FIG. 2, the present embodiment provides a file operation record traceability method, and the file operation record traceability method is applied to the file operation record traceability system of the above embodiment. Specifically, the file operation record traceability method comprises the following steps:

Step S1: Adding a preset file header to an original file to generate a target file, the preset file header containing file mark information for marking the uniqueness of the file and file flow information for recording the file user.

Specifically, the intelligent terminal is a terminal for a user to view and use a file, and since the operating system of the existing intelligent terminal cannot record operation record information of the user using a file and upload the operation record information to the cloud server, in order to realize the tracing of the file usage record, the present embodiment needs to first install an operating system extension module for recording operation record information of the user using a target file on the operating system of the intelligent terminal. The operating system extension module is different from an ordinary application program, which is only installed in the operating system, whereas the operating system extension module of the present embodiment is a part of the operating system.

After the operating system extension module is installed in the operating system of the intelligent terminal, it is necessary to cooperate with the file in the specific format of the present embodiment in order to realize the recording of the file usage process. The intelligent terminal of the present embodiment further needs to add a preset file header to the original file to generate a target file, the preset file header contains file mark information for marking the uniqueness of the file and file flow information for recording the file user, and each target file has unique file mark information, that is, the target file and the file mark information correspond to each other one-to-one. The intelligent terminal records the current user information into the file flow information when the user of the target file is changed, and the file flow information records all the file users, that is, the file users are recorded once every time the target file is transmitted or used. That is to say, all users who have used the target file will be recorded in the file flow information. Alternatively, the file user may be information that can uniquely identify the user's identity, such as the real name of the user, the registered account number, the physical address and the IP address of the intelligent terminal.

The original file referred to herein refers to a file in which the file operation record traceability system of the present embodiment is not used, that is, any file in the prior art, where the file refers to a data set containing a certain amount of data, for example, the original file may be a word file, a PDF file, a picture file, an audio file, a video file, a drawing file, or the like. It can be understood that when the original file is converted to the target file, the subsequent target file can be directly used after being transferred to other intelligent terminals, and there is no need to add a preset file header to the target file again.

It should be noted that when the intelligent terminal adds a preset file header to the original file to generate the target file, the normal use of the original file will not be affected, and the operating system can still call the application program corresponding to the target file when the target file is used. That is to say, when the original file is converted to the target file of a specific format, the correspondence between the original file and the application program is still retained, thus ensuring that the original file can be used normally after being converted to the target file.

Step 2: The operating system of the intelligent terminal records operation record information of the target file in the process of using the target file by the intelligent terminal.

Specifically, when using the target file, the intelligent terminal calls the application program corresponding to the target file to use the target file. In the process of using the target file, the operating system of the intelligent terminal records operation record information of the target file in the process of using the target file, and the operation record information refers to various operations performed by the user in the process of using the target file. Optionally, the operation record information comprises, but is not limited to, file usage time, file editing operation, file copying operation, file transfer operation, file printing operation, file screenshot operation, etc., and specific contents of the operation record information to be recorded can be selected as needed in the system setting process.

Step S3: The intelligent terminal uploads the operation record information, the file mark information, and the current user information in the file flow information to the cloud server for storage.

Specifically, after acquiring the operation record information, the operating system of the intelligent terminal uploads the operation record information, the file mark information, and the current user information in the file flow information, and the correspondence relationship in the operation record information, the file mark information, and the current user information to the cloud server.

After receiving the operation record information, the file mark information, and the current user information, and the correspondence between them, the cloud server stores the operation record information, the file mark information, and the current user information, and the correspondence between them in the cloud server, In order to facilitate data storage and user search, because the file mark information is the unique mark information of the target file, the data is stored by the file mark information, that is, the operation record information corresponding to the same file mark information and the user information are stored together. Alternatively, when operation record information and user information corresponding to the same file mark information are stored together, the operation record information and user information are stored in chronological order.

Step S4: The management terminal sends a viewing request with the file mark information to the cloud server, and the cloud server sends the operation record information and the user information corresponding to the file mark information to the management terminal.

Specifically, when the user needs to view the destination file for traceability, the management terminal sends a viewing request with file tag information to the cloud server. The cloud server searches the operation record information and the user information corresponding to the file mark information, and sends the searched operation record information and the user information to the management terminal, and the management terminal displays the operation record information and the user information for the user to view. Further, if it is desired to accurately search the operation record information of a certain user using a certain destination file, the viewing request sent by the management terminal comprises the file mark information and the user information, and the cloud server searches the operation record information corresponding to both the file mark information and the user information, and sends the searched operation record information to the management terminal, and the management terminal displays the operation record information for the user to view.

The file operation record traceability method of the present embodiment uses a file header and an operating system to record the file operation record, and uses a cloud to store the file operation record, thereby facilitating the traceability of the entire usage process of the file.

In summary, the advantages of the present invention as compared with the prior art are that, first, after the user obtains the file, the blood relationship of the file is very clear, and the file is convenient to be used as an advantageous proof in the transaction of assets to avoid disputes; Second, when the user obtains the file, the behaviors that the user wants to copy, transmit, print, take screenshots, etc. will be monitored and recorded. It is easy to trace the source of the file behavior and find the source of the file leakage.

In the present specification, each embodiment is described in a progressive manner, and the differences between each embodiment and other embodiments are emphasized, and the same and similar parts between each embodiment can be referred to each other. As for the apparatus disclosed in the embodiment, since the apparatus corresponds to the method disclosed in the embodiment, the description is relatively simple, and the description of the method section can be referred to for related details.

The skilled in the art may further appreciate that the elements and algorithmic steps of the examples described in connection with the embodiments disclosed herein can be implemented in electronic hardware, computer software, or a combination of both, and in order to clearly illustrate the interchangeability of hardware and software, the components and steps of the examples have been described generally in terms of functionality in the foregoing description. Whether these functions are performed in hardware or software depends on the specific application and design constraints of the technical solution. The skilled in the art may use different methods for implementing the described functions for each particular application, but such implementations should not be considered beyond the scope of the present invention.

The steps of the methods or algorithms described in connection with the embodiments disclosed herein may be implemented directly in hardware, a processor-executed software module, or a combination of both. The software module may be placed in random access memory (RAM), memory, read-only memory (ROM), electrically programmable ROM, electrically erasable programmable ROM, registers, hard disk, removable magnetic disk, CD-ROM, or any other form of storage medium known in the art.

The above embodiments are merely for illustrating the technical concept and features of the present invention, and are intended to enable those skilled in the art to understand the contents of the present invention and carry out the present invention accordingly, and do not limit the scope of protection of the present invention. All changes and modifications equivalent to the scope of the claims of the present invention should fall within the scope of the claims of the present invention.

What is claimed is:

1. A file operation record traceability system, comprising an intelligent terminal, a cloud server, and a management terminal, wherein the cloud server communicatively connects the intelligent terminal and the management terminal;
the intelligent terminal is used for adding a preset file header to an original file to generate a target file, and the preset file header contains file mark information for marking the uniqueness of the file and file flow information for recording the file user; and the operating system of the intelligent terminal records operation record information of the target file in the process of using the target file; and uploading the operation record information, the file mark information, and current user information in the file flow information to the cloud server;
the management terminal is used for sending a viewing request with the file mark information to the cloud server;
the cloud server is used for storing the operation record information, the file mark information, and the user information, and sending the operation record information and the user information corresponding to the file mark information in the viewing request to the management terminal.

2. The file operation record traceability system according to claim 1, wherein the intelligent terminal is further used for recording current user information into the file flow information when the target file changes a user.

3. The file operation record traceability system according to claim 1, wherein the intelligent terminal calls an application program corresponding to the target file to use the target file.

4. The file operation record traceability system according to claim 1, wherein the operating system of the intelligent terminal is installed with an operating system extension module for recording the operation record information of the user using the target file;
when the intelligent terminal derives a new target file from the target file, the new target file inherits file mark information and file flow information of the target file, and generates new file mark information.

5. The file operation record traceability system according to claim 1, wherein the operation record information comprises at least one of a file usage time, a file editing operation, a file copying operation, a file transfer operation, a file printing operation, and a file screenshot operation.

6. A file operation record traceability method, comprising the following steps:
adding a preset file header to an original file to generate a target file, wherein the preset file header contains file mark information for marking file uniqueness and file flow information for recording file users;
the operating system of the intelligent terminal records operation record information of the target file in the process of using the target file by the intelligent terminal;
the intelligent terminal uploads current user information in the operation record information, the file mark information, and user information in the file flow information to a cloud server for storage;
the management terminal sends a viewing request with the file mark information to the cloud server, and the cloud server sends the operation record information and user information corresponding to the file mark information to the management terminal.

7. The file operation record traceability method according to claim 6, wherein the method further comprises:
recording current user information into the file flow information when the user of the target file is changed.

8. The file operation record traceability method according to claim 6, wherein the intelligent terminal uses the target file comprises:
the intelligent terminal calls an application program corresponding to the target file for using the target file.

9. The file operation record traceability method according to claim 6, wherein before the operating system of the intelligent terminal records the operation record information of the target file in the process of using the target file by the intelligent terminal, the operating system extension module for recording the operation record information of the user using the file is added to the operating system of the intelligent terminal;
after adding a preset file header to an original file to generate a target file, further comprises: when the intelligent terminal derives a new target file from the target file, the new target file inherits file mark information and file flow information of the target file and generates new file mark information.

10. The file operation record traceability method according to claim 6, wherein the operation record information comprises at least one of a file usage time, a file editing operation, a file copying operation, a file transfer operation, a file printing operation, and a file screenshot operation.
